(19) United States
(12) Patent Application Publication
(10) Pub. No.: US 2006/0048175 A1
(43) Pub. Date: Mar. 2, 2006

(54) Optical disc drive with buffering

(75) Inventors: Bin-Hai Guo, Shenzhen (CN); Chien-Ting Lo, Tucheng (TW); Li-Ming Wan, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/216,232

(22) Filed: Aug. 31, 2005

(30) Foreign Application Priority Data
Aug. 31, 2004 (CN) 200420083690.3

(51) Int. Cl. G11B 7/08

(52) U.S. Cl. 720/694

(57) ABSTRACT

A disc drive includes a drive unit, a frame receiving the drive unit therein, a subframe pivotally mounted to the frame, a slider slidably mounted to the frame, and a buffer formed at an inner surface of the frame for absorbing vibrations of the subframe. The drive unit is fastened to the frame via a plurality of vibration-dampers. The subframe is used for raising and lowering of the drive unit. The slider is used for raising and lowering the subframe. The buffer and the slider cooperatively position the subframe in position during a loading operation.

### BACKGROUND

1. Field of the Invention

The present invention generally relates to optical disc drives, and particularly to an optical disc drive which is capable of effectively absorbing vibrations generated by a drive unit.

2. Related Art

Optical disc drives are widely used in personal computers and in entertainment equipment such as DVD (Digital Video Disc) players. Generally, a drive unit controls a spindle motor thereof to rotate an optical disc received in a tray of an optical disc drive. An optical pickup module moves along a radial direction of the optical disc to read a data stream recorded in the optical disc. If the optical disc is not placed in an appropriate position, the optical disc may be rotated unsteadily. This may cause the drive unit to vibrate. The vibration may adversely affect the normal operation of the optical pickup module. Therefore, measures should be taken to effectively absorb the vibration caused by the drive unit.

A conventional optical disc drive as disclosed in a Chinese patent application No. 03267229.2 is illustrated in FIG. 9. The disc drive includes a frame 1a, a slider 2a, a subframe 3a, and a driving unit 4a. The spindle motor 41a is for rotating a disc (not shown). The pickup module 42a is for reading information recorded on the disc. The feeding module 43a of the driving unit 4a is for conveying the pickup module 42a. The driving unit 4a is supported by the frame la and the subframe 3a, via a plurality of isolators (not labeled). The subframe 3a is pivotally mounted to the frame 1a, for moving the traverse module 4a upward or downward. The subframe 3a is engaged with the slider 2a, which is driven by a loading motor (not labeled). A pair of first sponges 30a and second sponges 40a are respectively attached to lateral sides (not labeled) of the subframe 3a and front comers of the frame 1a, in order to absorb vibrations during a loading or unloading operation.

However, the procedure for manufacturing the above-mentioned disc drive is rather complex. It is unduly difficult to attach the first and second sponges 30a, 40a to the frame 1a and the subframe 3a.

Therefore, a heretofore unaddressed need exists in the industry to address the aforementioned deficiencies and inadequacies.

### SUMMARY

Briefly described, one embodiment of a disc drive, among others, can be implemented as described herein.

A disc drive includes a drive unit, a frame receiving the drive unit therein, a subframe pivotally mounted to the frame, a slider slidably mounted to the frame, and a buffer formed at an inner surface of the frame for absorbing vibrations of the subframe. The drive unit is fastened to the frame via a plurality of vibration-dampers. The subframe is used for raising and lowering of the drive unit. The slider is used for raising and lowering the subframe. The buffer and the slider cooperatively position the subframe in position during a loading operation.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a partially exploded, isometric view of an optical disc drive in accordance with an exemplary embodiment of the present invention.

FIG. 2 is similar to FIG. 1, but viewed from another aspect.

FIG. 3 is an exploded, isometric view of part of the disc drive of FIG. 1, not showing a tray of the disc drive.

FIG. 4 is similar to FIG. 3, but viewed from another aspect.

FIG. 5 is an enlarged, view of a circled portion V of FIG. 4.

FIG. 6 is an enlarged view of a circled portion VI of FIG. 4.

FIG. 7 is an enlarged view of a circled portion VII of FIG. 4.

FIG. 8 is an enlarged, exploded, isometric view of a frame and a subframe of the disc drive of FIG. 1, but viewed from a bottom aspect.

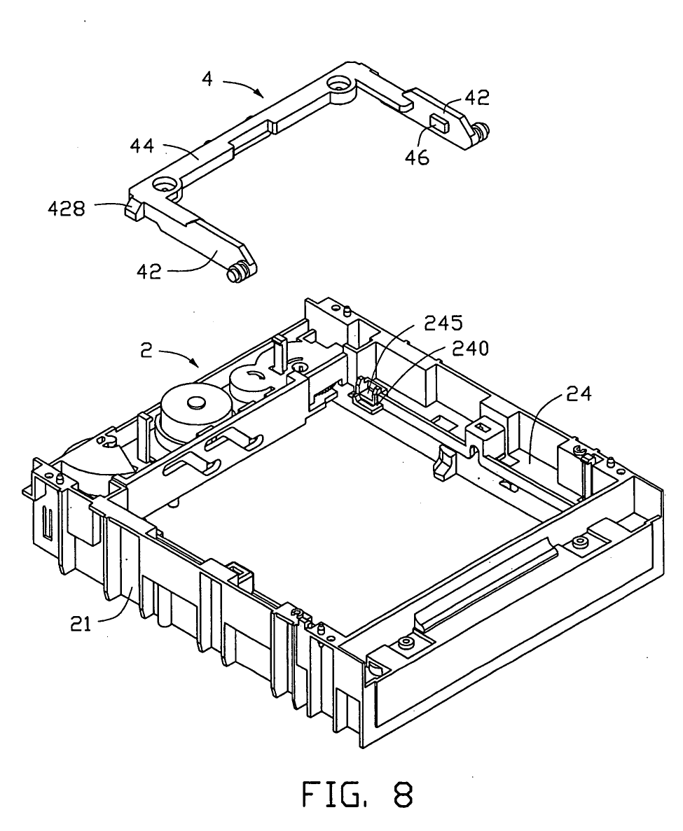

FIG. 9 is an exploded, isometric view of a conventional optical disc drive.

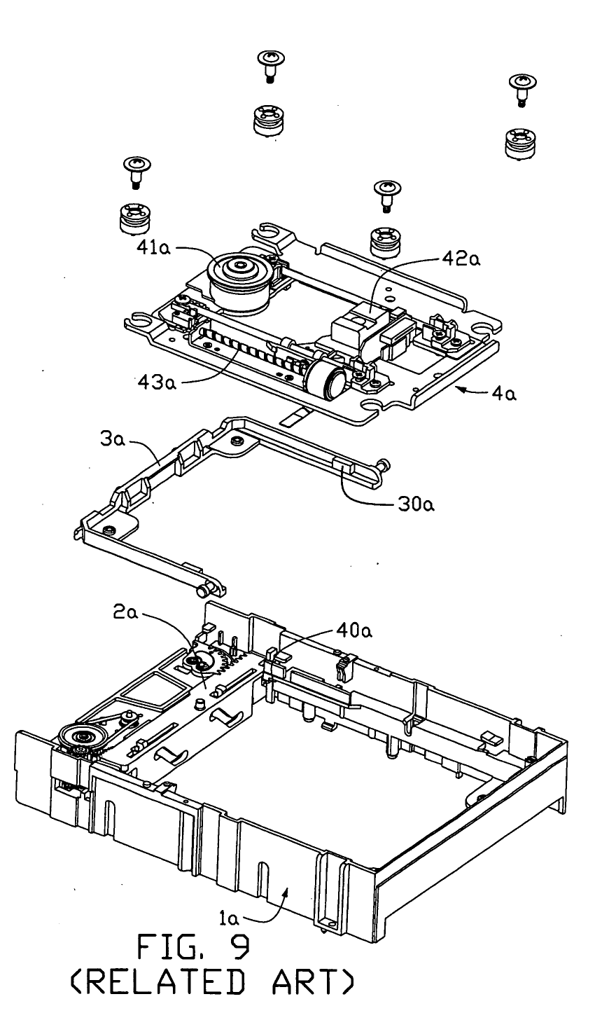

### DETAILED DESCRIPTION OF PREFERRED EMBODIMENTS

Reference will now be made to the drawing figures to describe the preferred embodiments of the present invention in detail.

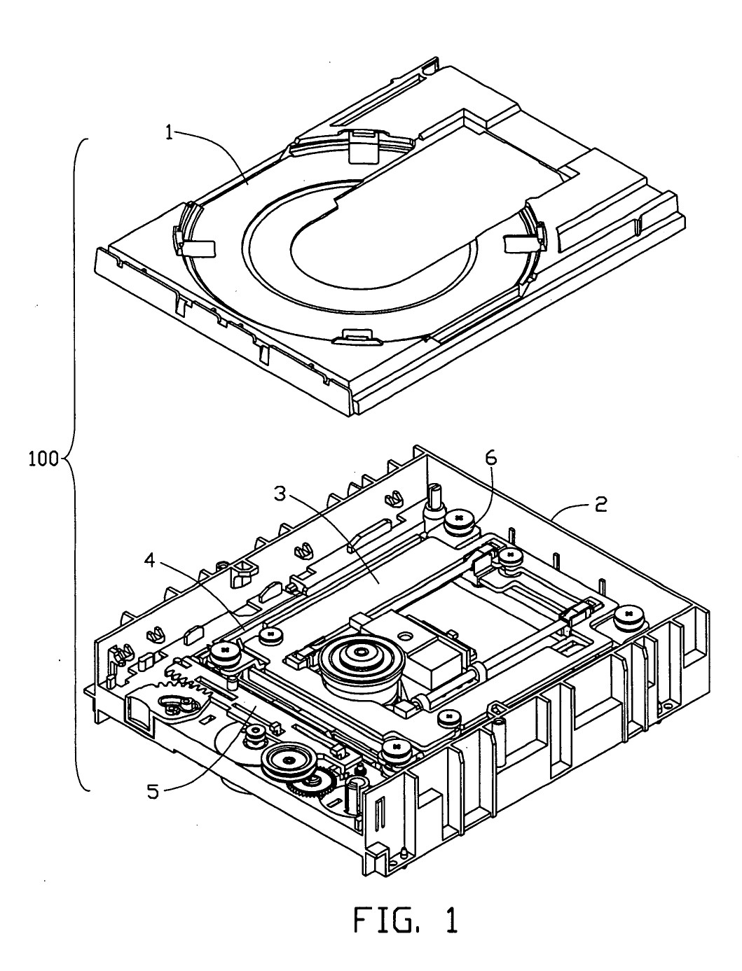

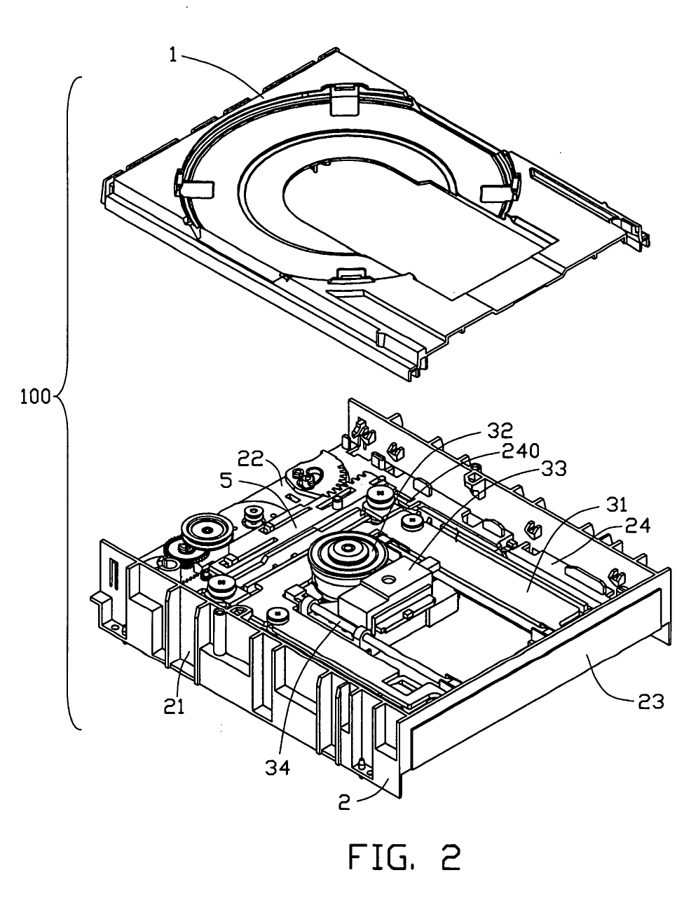

As shown in FIG. 1 and FIG. 2, an optical disc drive 100 according to an exemplary embodiment of the present invention includes a tray 1, a frame 2, a drive unit 3, a subframe 4, a cam slider 5, and four vibration-dampers 6. The tray 1 is used for loading a disc (not shown) thereon and transporting the disc into and out of the frame 2. The frame 2 is for receiving the aforementioned components therein. The drive unit 3 is a core module of the disc drive 100, for reading and/or recording information from/onto the disc. The drive unit 3 is mounted on and supported by the frame 2 and the subframe 4. The subframe 4 has a front end thereof pivotally mounted to the frame 2, and a rear end engaged with the cam slider 5. The subframe 4 is for moving the drive unit 3 upward or downward.

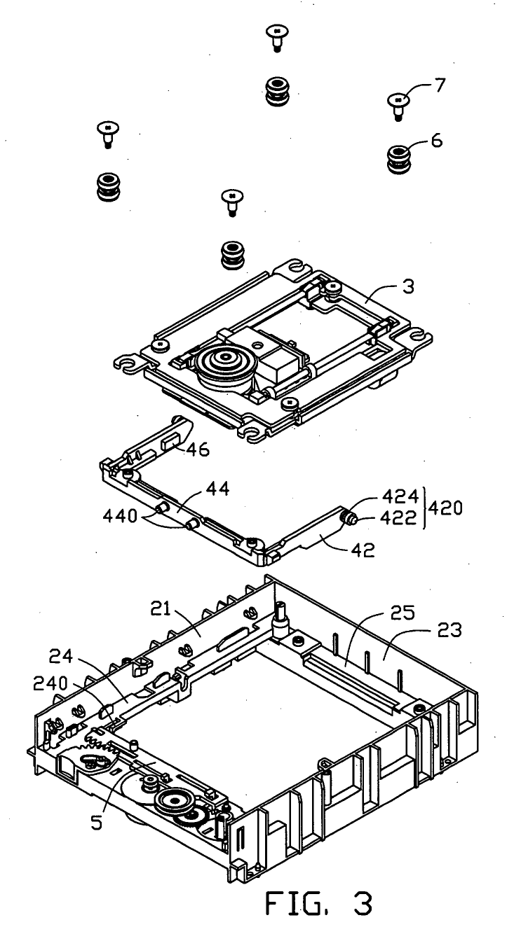

Now referring to FIG. 2, the frame 2 comprises a pair of side walls 21, a back wall 23, a front bracket 22, a pair of side brackets 24, and a back bracket 25 (as shown in FIG. 3). The front bracket 24, the side brackets 24 and the back bracket 25 are interconnected with each other, and are substantially surrounded by the side walls 21 and the back wall 23.

The drive unit 3 includes a chassis 31, a spindle motor 32, a pickup 33, and a feeding mechanism 34. The spindle motor 32, the pickup 33, and the feeding mechanism 34 are mounted on the chassis 31. The spindle motor 32 is for rotating the disc. The pickup 33 is for reading or recording information from/onto the disc. The feeding mechanism 34 is for reciprocatingly conveying the pickup 33.

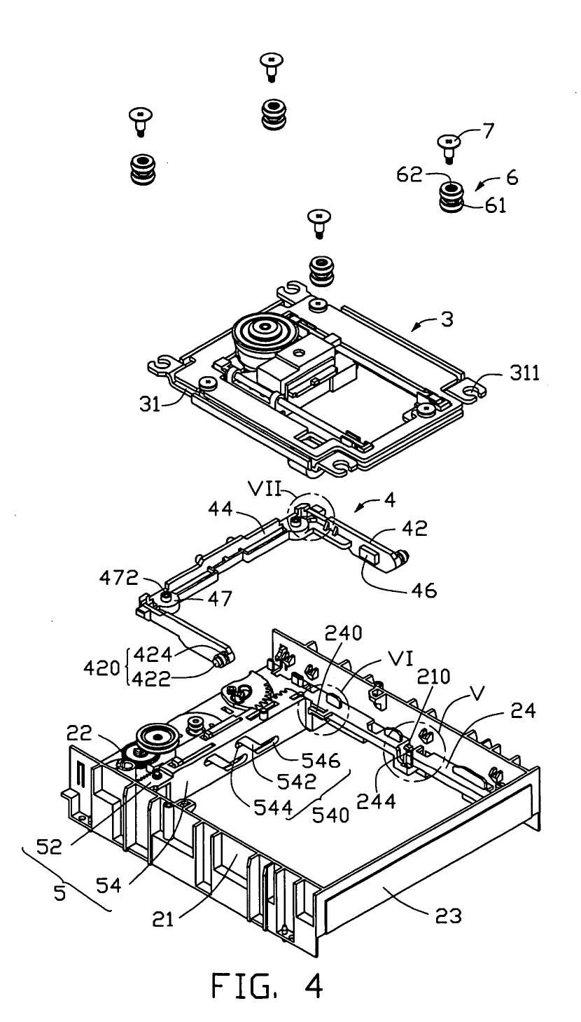

Referring to FIG. 3 and FIG. 4, a front portion of the drive unit 3 is secured to the front end of the subframe 4 by two screw bolts 7 cushioned with two vibration-dampers 6 respectively. A back portion of the drive unit 3 is secured to the frame 2 by another two screw bolts 7 cushioned with another two vibration-dampers 6 respectively. In more detail, four mounting clamps 311 are defined at four comers (not labeled) of the chassis 31. Each vibration-damper 6 defines an annular groove 61 in an external circumferential wall thereof. The mounting clamps 331 clamp middle portions of the vibration-dampers 6 at the annular grooves 61. A through hole 62 is defined in each vibration-damper 6 for extension of a corresponding screw bolt 7 therethrough. The screw bolts 7 extend through the through holes 62 of the vibration-dampers 6, and are respectively threaded into corresponding screw holes 472 defined in a deck 47 of a subframe 4 and corresponding screw holes (not labeled) defined in the back bracket 25 of the frame 2.

The subframe 4 includes a pair of side beams 42, and a cross beam 44 interconnecting the side beams 42. A pivot end 420 extends outward from a distal end of each side beam 42. The pivot end 420 includes a boss 422, and a neck portion 424 adjacent the boss 422. A pair of guiding pins 440 extends forward from a front side of the cross beam 44. A pair of cushions 46 is attached to inner surfaces of the side beams 42 respectively, in order to absorb vibrations caused by the drive unit 3.

The cam slider 5 is slidably mounted to a back side of the front bracket 22 of the frame 2. The cam slider 5 includes a horizontal portion 52 and a vertical portion 54. The horizontal portion 52 is driven by a loading motor (not labeled) to slide transversely relative to the front bracket 22. The vertical portion 54 defines two parallel Z-shaped slots 540 for receiving the guiding pins 440 of the cross beam 40. Each Z-shaped slot 540 includes an upper portion 544, a lower portion 546, and a slanting portion 542 interconnecting the upper portion 544 and the lower portion 546.

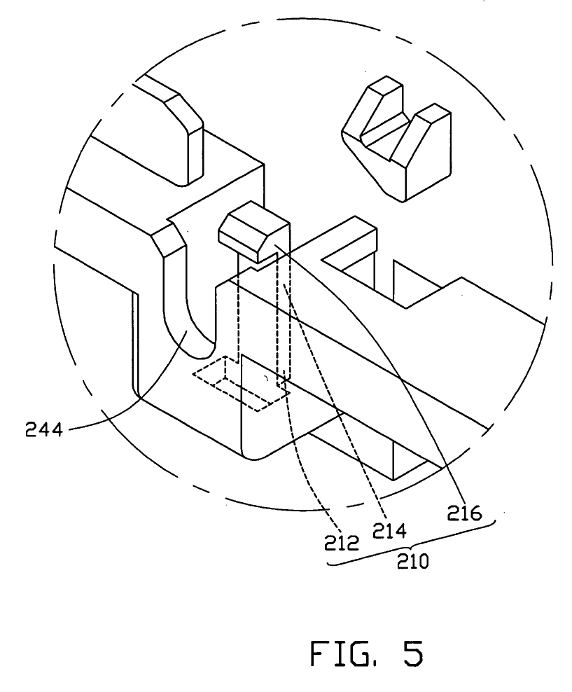

Also referring to FIG. 5, a notch 244 is defined in each side bracket 24, for receiving a corresponding pivot end 420 of the subframe 4 therein. A flexible arm 210 is located adjacent the notch 244, and extends upward from each side bracket 24. The flexible arm 210 includes a stiff end 212, and a free end 214 with a claw 216 formed at a distal end thereof. The pivot ends 420 of the subframe 4 are coupled to the side bracket 24 of the frame 2, with the neck portions 424 of the pivot ends 420 of the subframe 4 being engaged in the notches 244 of the pivot ends 420 of the subframe 4, and the bosses 422 of the pivot ends 420 of the subframe 4 being clasped by the claws 216 of the flexible arms 210 of the side brackets 24.

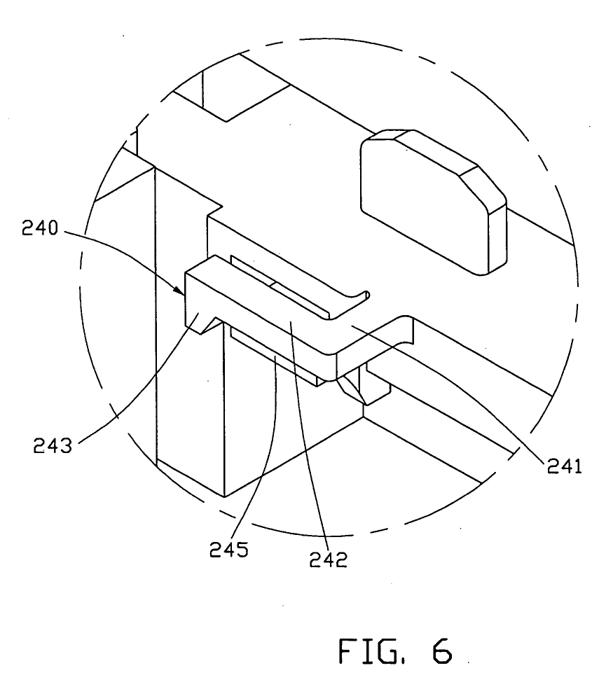

Referring to FIG. 6, an L-shaped buffer 240 is a resilient arm formed on an inner surface (not labeled) of each side bracket 24. Each buffer 240 includes a connecting portion 241 extending perpendicularly from the inner surface of the side bracket 24, a buffering portion 242 extending horizontally from a distal end of the connecting portion 241, and a contact portion 243 formed at a lower portion of a distal end of the buffering portion 242. The buffering portion 242 is spaced away from and parallel to the inner surface of the side bracket 24.

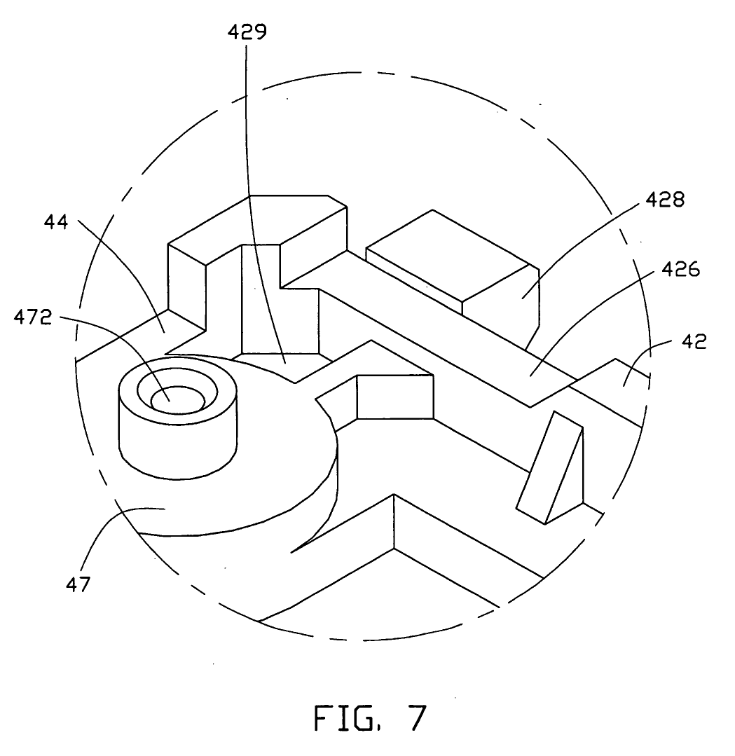

Referring to FIG. 7, a concavity 426 is defined in each side beam 42, adjacent a joint portion between the side beam 42 and the cross beam 44. The concavity 426 is for receiving the connecting portion 241 of a corresponding buffer 240 therein. A width of the concavity 426 is approximately equal to, or slightly less than, a distance between the corresponding buffering portion 242 and the inner surface of the corresponding side bracket 24. A guide tongue 428 is respectively formed at an outer surface (not labeled) of each side beam 42. A contact surface 429 is provided at each corner of the subframe 4, for contacting the contact portion 243 of a corresponding buffer 240 during a loading operation of the driving unit 3. A guide trough 245 is defined at a lower portion of each side bracket 24, for guiding a corresponding guide tongue 428 to extend therethrough during the loading operation.

In assembly of the disc drive 100, the cam slider 5 is slideably mounted to the back portion of the front bracket 22, and is disposed in an unloading position. The guiding pins 440 of the subframe 4 are inserted into the lower portions 546 of the Z-shaped slots 540. The pivot ends 420 of the subframe 4 are coupled to the side bracket 24 of the frame 2, with the neck portions 424 of the pivot ends 420 of the subframe 4 being engaged in the notches 244 of the pivot ends 420 of the subframe 4, and the bosses 422 of the pivot ends 420 of the subframe 4 being clasped by the claws 216 of the flexible arms 210 of the side bracket 216. By doing so, the subframe 4 is vertically and movably coupled to the frame 2 and the subframe 4. The vibration-dampers 6 are clamped by the mounting clamps 311 of the drive unit 3. The drive unit 3 is then fastened to the frame 2 and the subframe 4 by the screw bolts 7. Thus, the front portion of the drive unit 3 is fixed on subframe 4, and the back portion of the drive unit 3 is fixed on the frame 2. The tray 1 is coupled to the side brackets 24 of the frame 2.

In operation, when the tray 1 slides into or out of the frame 2, the cam slider 5 is correspondingly driven to slide transversely along the front bracket 22. When the cam slider 5 slides from one side to the other side, the subframe 4 is rotated relative to the pivot ends 420 thereof, with the front end of the subframe 4 being correspondingly moved upward or downward. The drive unit 3 is raised or lowered together with the subframe 4. When the drive unit 3 is raised, the cross beam 44 of the subframe 4 is moved upward. The guide tongues 428 of the side beams 42 are moved into the guide troughs 245 of the side brackets 24, and are movably guided by the guide troughs 245. At the same time, the contact surfaces 429 are raised until they are brought into contact with the contacting portions 243 of the buffers 240. As a result, the connecting portions 241 of the buffers 240 are received in the concavities 426. Portions of the side beams 42 under the concavities 426 are sandwiched between the contact portions 243 and the inner surfaces of the side brackets 24. The buffering portions 242 and the contact portions 243 of the buffers 240 are slightly movable up and down relative to the connecting portions 241 of the buffers 240. Vibration of the drive unit 3 and the subframe 4 due to a sudden impact on the side brackets 24 can be effectively absorbed by the buffers 240. The subframe 4 is positioned between the contact portions 243 of the buffers 240 and the upper portions 544 of the cam slider 5. This can further prevent the subframe 4 from vibration. Further, slight horizontal vibration of the drive unit 3 can be further absorbed by the cushions 46 attached at the inner surfaces of the side beams 42 and the vibration-dampers 6 of the drive unit 3.

It should be noted that the buffers 240 may be integrally formed on the frame 2. This can simplify the manufacturing procedure of the frame 2, thereby improving the efficiency of mass production. In addition, the cushions 46 can also be omitted. Because the subframe 4 is horizontally positioned by the screw bolts 7, slight horizontal vibration can still be effectively absorbed by the vibration-dampers 6.

It should be emphasized that the above-described embodiments, including any preferred embodiments, are merely possible examples of implementation of the principles of the invention, and are merely set forth for a clear understanding of the principles of the invention. Many variations and modifications may be made to the above-described embodiments without departing substantially from the spirit and principles of the invention. All such modifications and variations are intended to be included herein within the scope of this disclosure and the present invention and be protected by the following claims.

What is claimed is:

1. A disc drive comprising:
a drive unit;
a frame receiving the drive unit therein, the drive unit being fastened to the frame via a plurality of vibration-dampers;
a subframe pivotally mounted to the frame for raising and lowering of the drive unit;
a slider slidably mounted to the frame for raising and lowering the subframe; and
a buffer formed at an inner surface of the frame for absorbing vibrations of the subframe, the buffer and the slider cooperatively positioning the subframe in position during a loading operation.

2. The disc drive according to claim 1, wherein the buffer comprises a connecting portion connecting the buffer to the frame, a buffering portion, and a contact portion, and the buffering portion is slightly movable about the connecting portion.

3. The disc drive according to claim 2, wherein the contact portion formed at a distal end of the buffering portion contacts the subframe.

4. The disc drive according to claim 3, further comprising a guide tongue formed at a side of the subframe and a guide trough defined at the frame, the guide tongue being adapted for engagement with the guide trough and guiding a movement of the subframe.

5. The disc drive according to claim 4, wherein the connecting portion of the buffer perpendicularly extends inward from the inner surface of the frame.

6. The disc drive according to claim 5, wherein the buffering portion is spaced away from and parallel to the inner surface of the frame.

7. The disc drive according to claim 6, wherein a width of the space between the buffering portion and the inner surface of the frame is substantially equal to, or slightly larger than, a width of the side of the subframe.

8. The disc drive according to claim 7, wherein a cushion is attached to an inner surface of the subframe.

9. A disc drive for reading and/or recording from/to a data storage disc, the disc drive comprising:
a drive unit;
a frame for partially supporting the drive unit;
a subframe supported by the frame for partially supporting and lifting or lowering the drive unit; and
a buffer formed at the frame for absorbing vibrations of the subframe, the buffer and a portion of the frame cooperatively positioning a portion of the subframe during a loading operation.

10. The disc drive according to claim 9, wherein the buffer comprises a connecting portion, and a buffering portion slightly movable relative to the connecting portion.

11. The disc drive according to claim 9, further comprising a guide tongue extending from a side of the subframe.

12. The disc drive according to claim 11, wherein the frame defines a guide trough.

13. The disc drive according to claim 12, further comprising a cushion attached to a side of the subframe.

14. A disc drive comprising:
a drive unit for performing functions of said disc drive;
a frame substantially and supportively surrounding said drive unit;
a subframe movably attachable to said frame so as to cooperatively support said drive unit together with said frame, and capable of urging movement of said drive unit relative to said frame to perform said functions; and
a buffer formed between said frame and said subframe, and capable of resiliently contacting with at least one of said frame and said subframe so as to absorb any vibration of the subframe partially caused by said movement of said drive unit.

15. The disc drive according to claim 14, wherein said buffer comprises at least one L-shaped resilient arm connectively extending from an inner surface of said frame and resiliently contactable with said subframe.
